(19) United States
(12) Patent Application Publication
(10) Pub. No.: US 2015/0288885 A1
(43) Pub. Date: Oct. 8, 2015

(54) Method and Apparatus for Controlling Camera Devices

(71) Applicant: TENCENT TECHNOLOGY (SHENZHEN) COMPANY LIMITED, Shenzhen (CN)

(72) Inventors: Fei Cheng, Shenzhen (CN); Shizhu Huang, Shenzhen (CN); Feiyun Li, Shenzhen (CN)

(21) Appl. No.: 14/741,553

(22) Filed: Jun. 17, 2015

Related U.S. Application Data
(63) Continuation of application No. PCT/CN2013/089342, filed on Dec. 13, 2013.

(30) Foreign Application Priority Data
Dec. 24, 2012 (CN) 201210567837.5

(51) Int. Cl. H04N 5/232

(52) U.S. Cl. CPC H04N 5/23293; H04N 5/23222; H04N 5/23229

(57) ABSTRACT

A method and apparatus for controlling camera devices are described. The method includes: reading a current data frame of a viewfinder of a started camera device; judging whether the started camera device is a front camera device; judging whether a beautification function of the started camera device is turned on if the started camera device is the front camera device; if the beautification function of the camera device is started, performing a beautifying process on data of the viewfinder, and drawing a data frame obtained through the beautifying process on a screen for displaying.

### CROSS-REFERENCES TO RELATED APPLICATIONS

This application is a continuation of International Application No. PCT/CN2013/089342, filed on Dec. 13, 2013, which claims priority to Chinese patent application No. 201210567837.5, filed on Dec. 24, 2012, the content of which are incorporated herein by reference in their entirety.

### FIELD OF THE DISCLOSURE

The present disclosure relates to communication technology, and more particularly to a method and apparatus for controlling camera devices.

### BACKGROUND

With the development of the social networking functions, more and more users use front cameras of mobile terminals such as mobile phones to take selfies. When a user uses a front camera to take a selfie, the user can adjust shooting angles according to a selfie displayed on a screen of a mobile terminal, thereby determining final imaging effect.

However, in the related art, the front camera usually has low pixels and weak light effect, which cause the image blackish and affects the final imaging effect.

### SUMMARY

One embodiment of the present disclosure provides a method and apparatus for controlling camera devices, which can automatically start a beautification function to optimize an imaging effect of an image captured by a front camera of a mobile terminal.

A method for controlling camera devices includes: reading a current data frame of a viewfinder of a started camera device; judging whether the started camera device is a front camera device; judging whether a beautification function of the started camera device is turned on if the started camera device is the front camera device; if the beautification function of the started camera device is started, performing a beautifying process on data of the viewfinder, and drawing a data frame obtained through the beautifying process on a screen for displaying.

An apparatus for controlling camera devices includes: a reading unit, a judgment unit, a processing unit and a drawing unit; wherein the reading unit is configured to read a current data frame of a viewfinder of a started camera device; the judgment unit is configured to judge whether the started camera device is a front camera device; if the started camera device is the front camera device, judge whether a beautification function of the started camera device is started; the processing unit is configured to, if the judgment unit judges that the beautification function of the started camera device is started, perform a beautifying process on the data of the viewfinder read by the reading unit; the drawing unit is configured to draw a data frame obtained through the beautifying process implemented by the processing unit on a screen for displaying.

A mobile terminal includes a processor, a memory, a front camera device, a rear camera device and a screen; wherein the processor and the memory are connected with each other via an internal bus; the memory stores a set of instructions for performing a method for controlling camera devices, the set of instructions to direct the processor to perform acts of:

reading a current data frame of a viewfinder of a started camera device when the started camera device is started for taking a selfie;

judging whether the started camera device is the front camera device;

if the started camera device is the front camera device, judging whether a beautification function of the front camera device is turned on;

if the beautification function of the front camera device is started, judging whether receiving an instruction of turning off the beautification function of the front camera device;

if not receiving the instruction of turning off the beautification function of the front camera device, automatically performing a beautifying process on data of the viewfinder and drawing a data frame obtained through the beautifying process on the screen for displaying;

if receiving the instruction of turning off the beautification function of the front camera device, turning off the beautification function of the front camera device.

In the above method and apparatus for controlling camera devices, the processor of the mobile terminal can read the current data frame of the viewfinder of the started camera device and judges whether the camera device is a front camera device; if the camera device is a front camera device, further judges whether the beautification function of the camera device is started; if the beautification function of the camera device is started, performs a beautifying process on the read data of the viewfinder, and draws the data frame obtained through the beautifying process on the screen for displaying. By this way, through the automatic beautifying process, a selfie with a better imaging effect can be generated from the image captured by the front camera device which usually has lower pixels.

### BRIEF DESCRIPTION OF DRAWINGS

FIG. 1 is a flowchart of a method for controlling camera devices according to one embodiment of the present disclosure;

FIG. 2 is a flowchart of a method for controlling camera devices according to another embodiment of the present disclosure;

FIG. 3 is a schematic diagram of an apparatus for controlling camera devices according to one embodiment of the present disclosure;

FIG. 4 is a schematic diagram of an apparatus for controlling camera devices according to another embodiment of the present disclosure;

FIG. 5 is a schematic diagram of a mobile terminal according to one embodiment of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

One embodiment of the present disclosure provides a method for controlling camera devices, which can automatically use a beautification function to improve imaging effect of an image when a user uses a front camera to take a selfie.

The camera devices of one embodiment of the present disclosure can be camera devices of mobile terminals such as mobile phones and tablet computers.

Referring to FIG. 1, a method for controlling camera devices according to one embodiment of the present disclosure includes following steps.

101: reading a current data frame of a viewfinder of a started camera device.

When a user uses a front camera of a mobile terminal for shooting, the user starts the camera device and starts the viewfinder of the camera device. A processor of the mobile terminal reads the current data frame of the viewfinder. The current data frame includes data obtained by the viewfinder within its viewfinder range.

102: judging whether the camera device is a front camera device.

The processor judges whether the currently started camera device is a front camera device.

Many mobile phones or Tablet PCs are configured with two camera devices. Usually, one of the two camera devices has lower pixels, is located at a screen side of the mobile terminal and can be called as “front camera device”. Using the front camera device to take selfies can facilitate the user to view in real-time viewfinding situations of the camera device on a screen of the mobile terminal, and adjust shooting angles or the user's facial expressions in time according to the viewfinding situations, so that the user can get a satisfactory shooting effect. The other of the two camera devices has higher pixels, is located at a back side of the screen of the mobile terminal and can be called as rear camera device. When using the rear camera device to take selfies, the user needs to put the screen side of the mobile terminal outside, thus, the user cannot view in real-time viewfinding situations of the camera device on the screen of the mobile terminal and cannot adjust shooting angles or the user's facial expressions in time according to the viewfinding situations; therefore, it is difficult to control the shooting effect. One embodiment of the present disclosure can control the front camera device so as to get a better shooting effect.

103: if the camera device is a front camera device, judging whether a switch of a beautification function of the camera device is turned on.

If judging that the camera device is a front camera device, further judging whether the switch of the beautification function of the camera device is turned on.

104: if the switch of the beautification function of the camera device is turned on, performing a beautifying process on the data of the viewfinder, and drawing a data frame obtained through the beautifying process on the screen for displaying.

If the switch of the beautification function of the camera device is turned on, the processor performs the beautifying process on the data of the viewfinder, and converts the data frame obtained through the beautifying process into image data so as to be drawn on the screen for displaying. If the user is satisfied with the quality of the currently captured image, then the image obtained through the beautifying process is stored.

The beautifying process of one embodiment of the present disclosure refers to all processing means which can beautify the image captured by the camera device, such as exposure, white balance, light reduction, noise suppression, brightness, contrast, blur, sharpen, soft light, whitening and so on.

In the above embodiment of the present disclosure, the processor of the mobile terminal can read the current data frame of the viewfinder of the started camera device and judges whether the camera device is a front camera device; if the camera device is a front camera device, further judges whether the beautification function of the camera device is started; if the beautification function of the camera device is started, performs a beautifying process on the read data of the viewfinder, and draws the data frame obtained through the beautifying process on the screen for displaying. By this way, through the automatic beautifying process, a selfie with a better imaging effect can be generated from the image captured by the front camera device which usually has lower pixels.

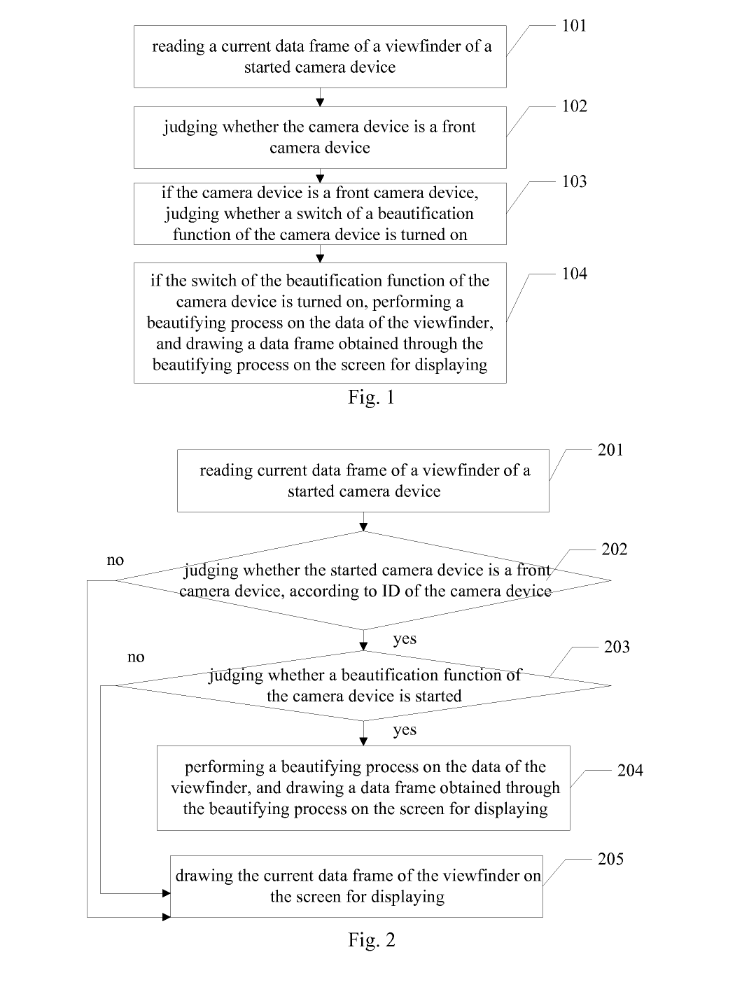

Referring to FIG. 2, a method for controlling camera devices according to another embodiment of the present disclosure includes following steps.

201: reading current data frame of a viewfinder of a started camera device.

When a user uses a camera device of a mobile terminal for shooting, the user starts the camera device and starts the viewfinder of the camera device. A processor of the mobile terminal reads the current data frame of the viewfinder. The current data frame includes data obtained by the viewfinder within its viewfinder range.

202: judging whether the started camera device is a front camera device, according to an identification number of the camera device.

Each camera device of the mobile terminal has a unique identification (ID) number. For example, an ID number of the front camera device can be 1, and an ID number of the rear camera device can be 2. When one of the camera devices is started, the started camera device automatically sends its ID number to the processor of the mobile terminal.

The processor receives the ID number sent from the started camera device, and judges whether the started camera device is a front camera device.

In the above example, if the received ID number sent from the started camera device is 1, the processor judges that the started camera device is a front camera device.

If the started camera device is a front camera device, performing step 203; otherwise, performing step 205.

203: judging whether a beautification function of the camera device is started, according to a current setup parameter of the beautification function corresponding to the camera device.

If judging that the started camera device is a front camera device, then judging whether the beautification function of the camera device is started according to a current setup parameter of the beautification function corresponding to the camera device.

Specifically, the processor can detect the current setup parameter of the beautification function corresponding to the camera device. The current setup parameter can include a preset parameter value configured to identify the beautification function turned on or off. The current setup parameter can include a preset identifier bit configured to identify the beautification function turned on or off. For example, when the beautification function of the camera device is turned on, the identifier bit can be 1; when the beautification function of the camera device is turned off, the identifier bit can be 0. The processor detects a value of the identifier bit, and can judge that the beautification function of the camera device is turned on if the identifier bit is 1 and the beautification function of the camera device is turned off if the identifier bit is 0. This present disclosure does not specifically limit manners of setting parameters identifying the beautification function turned on or off.

If the beautification function of the camera device is started, performing step 204; otherwise, performing step 205.

204: performing a beautifying process on the data of the viewfinder, and drawing a data frame obtained through the beautifying process on the screen for displaying.

If a switch of the beautification function of the camera device is turned on, the processor performs the beautifying process on the data of the viewfinder, and converts the data frame obtained through the beautifying process into image data so as to be drawn on the screen for displaying. If the user is satisfied with the quality of the currently captured image, then the image obtained through the beautifying process is stored.

205: drawing the current data frame of the viewfinder on the screen for displaying.

If the processor judges that the camera device is not a front camera device, since the rear camera device usually has higher pixels and an image captured by the rear camera device in a good light shooting situation may not require the beautifying process, thus, the processor does not perform the beautifying process on the current data frame of the viewfinder and directly draws the current data frame of the viewfinder on the screen for displaying.

If the processor judges that the camera device is a front camera device and judges that the beautification function of the camera device is turned off, the processor does not perform the beautifying process on the current data frame of the viewfinder and directly draws the current data frame of the viewfinder on the screen for displaying.

In the embodiment, the beautification function of the camera device can be turned off. When the user does not think it is needed to perform the beautification process on one image, the user can send an instruction of turning off the beautification function of the camera device to the processor. The processor receives the instruction of turning off the beautification function of the camera device sent from the user and turns off the beautification function of the camera device.

In the embodiment, the processor of the mobile terminal reads the current data frame of the viewfinder. The current data frame includes data obtained by the viewfinder within its viewfinder range. The processor receives the ID number sent from the started camera device and judges whether the started camera device is a front camera device. If the started camera device is a front camera device, the processor judges whether the beautification function of the camera device is started according to the current setup parameter of the beautification function corresponding to the camera device. If the beautification function of the camera device is started, the processor performs a beautifying process on the data of the viewfinder and draws the data frame obtained through the beautifying process on the screen for displaying. By this way, through the automatic beautifying process, a selfie with a better imaging effect can be generated from the image captured by the front camera device which usually has lower pixels. If the camera device is not a front camera device or the beautification function of the camera device is turned off, the processor does not perform the beautifying process on the current data frame of the viewfinder and directly draws the current data frame of the viewfinder on the screen for displaying. Further, when the user does not think it is needed to perform the beautification process on one image, the user can send an instruction of turning off the beautification function of the camera device to the processor; the processor receives the instruction of turning off the beautification function of the camera device sent from the user and turns off the beautification function of the camera device, so that the user can choose whether to beautify the captured image according to whether the camera device is a front camera device, whether the beautification function is turned on and whether it is needed to perform the beautification process on the captured image, and thus the user has a greater range of choices.

Referring to FIG. 3, an apparatus for controlling camera devices according to one embodiment of the present disclosure includes a reading unit 301, a judgment unit 302, a processing unit 303 and a drawing unit 304.

The reading unit 301 is configured to read a current data frame of a viewfinder of a started camera device.

The judgment unit 302 is configured to judge whether the camera device is a front camera device.

The judgment unit 302 is further configured to, if the camera device is a front camera device, judge whether a beautification function of the camera device is started.

The processing unit 303 is configured to, if the judgment unit 302 judges that the beautification function of the camera device is started, perform a beautifying process on the data of the viewfinder read by the reading unit 301.

The drawing unit 304 is configured to draw a data frame obtained through the beautifying process implemented by the processing unit 303 on the screen for displaying.

The process that the various function modules of the apparatus for controlling the camera devices in this embodiment achieve their own functions are similar to the process of the method for controlling the camera devices in the previous embodiment shown in FIG. 1, and will not be repeated here.

In this embodiment, the reading unit 301 can read the current data frame of the viewfinder of the started camera device, and the judgment unit 302 judges whether the camera device is a front camera device. If the camera device is a front camera device, the judgment unit 302 further judges whether the beautification function of the camera device is started; if the beautification function of the camera device is started, the processing unit 303 performs a beautifying process on the read data of the viewfinder, and the drawing unit 304 draws the data frame obtained through the beautifying process on the screen for displaying. By this way, through the automatic beautifying process, a selfie with a better imaging effect can be generated from the image captured by the front camera device which usually has lower pixels.

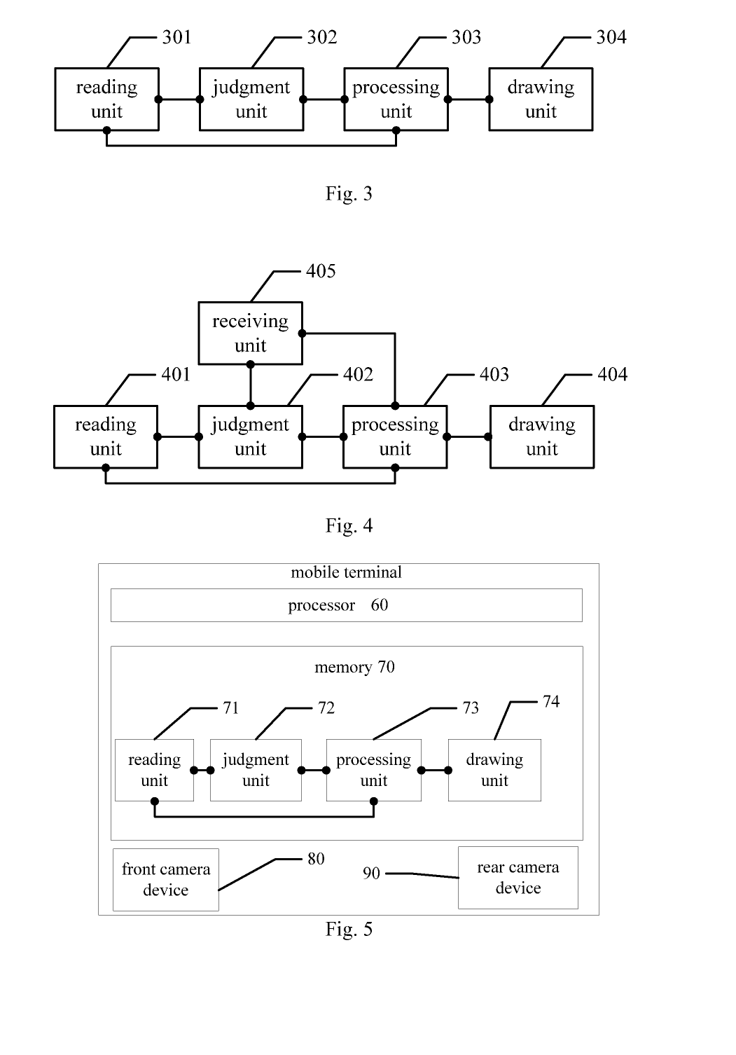

Referring to FIG. 4, an apparatus for controlling camera devices according to another embodiment of the present disclosure includes a reading unit 401, a judgment unit 402, a processing unit 403 and a drawing unit 404.

The reading unit 401 is configured to read a current data frame of a viewfinder of a started camera device.

The judgment unit 402 is configured to judge whether the camera device is a front camera device.

The judgment unit 402 is further configured to, if the camera device is a front camera device, judge whether a beautification function of the camera device is started.

The processing unit 403 is configured to, if the judgment unit 402 judges that the beautification function of the camera device is started, perform a beautifying process on the data of the viewfinder read by the reading unit 401.

The drawing unit 404 is configured to draw a data frame obtained through the beautifying process implemented by the processing unit 403 on the screen for displaying.

The apparatus for controlling camera devices in this embodiment can further include:

a receiving unit 405 configured to receive an identification (ID) number of the started camera device sent from the started camera device.

The judgment unit 402 is further configured to judge whether the started camera device is a front camera device according to the ID number of the started camera device received by the receiving unit 405.

The judgment unit 402 can also be further configured to judge whether the beautification function of the camera device is started, according to a current setup parameter of the beautification function corresponding to the camera device.

The drawing unit 404 is further configured to, if the judgment unit 402 judges that the started camera device is not a front camera device, draw the current data frame of the viewfinder on the screen for displaying.

The drawing unit 404 can also be configured to, if the judgment unit 402 judges that the beautification function of the camera device is turned off, draw the current data frame of the viewfinder on the screen for displaying.

Moreover, the receiving unit 405 can also be configured to receive an instruction of turning off the beautification function of the camera device sent from the user.

The processing unit 403 is further configured to, turn off the beautification function of the camera device according to the instruction of turning off the beautification function of the camera device received by the receiving unit 405.

The process that the various function modules of the apparatus for controlling the camera devices in this embodiment achieve their own functions are similar to the process of the method for controlling the camera devices in the previous embodiments shown in FIG. 1 and FIG. 2, and will not be repeated here.

In the embodiment, the reading unit 401 reads the current data frame of the viewfinder. The receiving unit 405 receives the ID number sent from the started camera device and the judgment unit 402 judges whether the started camera device is a front camera device. If the started camera device is a front camera device, the judgment unit 402 judges whether the beautification function of the camera device is started according to the current setup parameter of the beautification function corresponding to the camera device. If the beautification function of the camera device is started, the processing unit 403 performs a beautifying process on the data of the viewfinder and draws the data frame obtained through the beautifying process on the screen for displaying. By this way, through the automatic beautifying process, a selfie with a better imaging effect can be generated from the image captured by the front camera device which usually has lower pixels. If the camera device is not a front camera device or the beautification function of the camera device is turned off, the processing unit 403 does not perform the beautifying process on the current data frame of the viewfinder and the drawing unit 404 directly draws the current data frame of the viewfinder on the screen for displaying. Further, the receiving unit 405 can receive the instruction of turning off the beautification function of the camera device sent from the user and the processing unit 403 turns off the beautification function of the camera device, so that the user can choose whether to beautify the captured image according to whether the camera device is a front camera device, whether the beautification function is turned on and whether it is needed to perform the beautification process on the captured image, and thus the user has a greater range of choices.

FIG. 5 shows a mobile terminal according to one example of the present disclosure. The mobile terminal can be a mobile phone, a tablet computer, and so on. As shown in FIG. 5, the mobile terminal includes a processor 60, a memory 70, a front camera device 80, a rear camera device 90 and a screen. The front camera device 80 and the screen are located at a first side of the mobile terminal; the rear camera device 90 is located at a second side of the mobile terminal; the first side and the second side are opposite sides of the mobile terminal. The processor 60 and the memory 70 are connected with each other via an internal bus. The memory 70 may be a non-transitory computer-readable storage medium, and stores units of machine readable instructions executable by the processor 60, including a reading unit 71, a judgment unit 72, a processing unit 73 and a drawing unit 74. Functions of the reading unit 71, the judgment unit 72, the processing unit 73 and the drawing unit 74 are similar with the functions of the reading unit 301, the judgment unit 302, the processing unit 303 and the drawing unit 304. The functions may be implemented with the assistance of other modules, and may involve cooperation of multiple modules, e.g., may utilize processing functions of the processor 60, may relay on the internal bus for data transmission, and etc. For example, the reading unit 71 is configured to read a current data frame of a viewfinder of a started camera device; the judgment unit 72 is configured to judge whether the started camera device is the front camera device 80 or the rear camera device 90; if the started camera device is the front camera device 80, judge whether a beautification function of the started camera device is started; the processing unit 73 is configured to, if the judgment unit 72 judges that the beautification function of the started camera device is started, perform a beautifying process on data of the viewfinder read by the reading unit 71; the drawing unit 74 is configured to draw a data frame obtained through the beautifying process implemented by the processing unit 73 on the screen of the mobile terminal for displaying.

The methods, units, modules, and device described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or processor such as CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for controlling camera devices comprising:
reading a current data frame of a viewfinder of a started camera device;
judging whether the started camera device is a front camera device;
judging whether a beautification function of the started camera device is turned on if the started camera device is the front camera device;
if the beautification function of the started camera device is started, performing a beautifying process on data of the viewfinder and drawing a data frame obtained through the beautifying process on a screen for displaying.

2. The method of claim 1, wherein the judging whether the started camera device is a front camera device comprises:
receiving an identification number of the started camera device sent from the started camera device;
judging whether the started camera device is a front camera device according to the identification number of the started camera device.

3. The method of claim 1, wherein the judging whether a beautification function of the started camera device is turned on comprises:
judging whether the beautification function of the started camera device is started, according to a current setup parameter of the beautification function corresponding to the started camera device.

4. The method of claim 1, wherein after the judging whether the started camera device is a front camera device, the method further comprises:
if the started camera device is not the front camera device, drawing the current data frame of the viewfinder on the screen for displaying.

5. The method of claim 1, wherein after the judging whether a judging whether a beautification function of the started camera device is turned on, the method further comprises:
if the beautification function of the started camera device is turned off, drawing the current data frame of the viewfinder on the screen for displaying.

6. The method of claim 1, wherein the performing a beautifying process on data of the viewfinder comprises:
automatically performing the beautifying process on data of the viewfinder.

7. An apparatus for controlling camera devices comprising: a reading unit, a judgment unit, a processing unit and a drawing unit; wherein
the reading unit is configured to read a current data frame of a viewfinder of a started camera device;
the judgment unit is configured to judge whether the started camera device is a front camera device; if the started camera device is the front camera device, judge whether a beautification function of the started camera device is started;
the processing unit is configured to, if the judgment unit judges that the beautification function of the started camera device is started, perform a beautifying process on the data of the viewfinder read by the reading unit;
the drawing unit is configured to draw a data frame obtained through the beautifying process implemented by the processing unit on a screen for displaying.

8. The device of claim 7, further comprising:
a receiving unit configured to receive an identification number of the started camera device sent from the started camera device.

9. The device of claim 7, wherein
the judgment unit is further configured to judge whether the started camera device is a front camera device according to the identification number of the started camera device received by the receiving unit;
the judgment unit is further configured to judge whether the beautification function of the started camera device is started, according to a current setup parameter of the beautification function corresponding to the started camera device.

10. The device of claim 9, wherein
the drawing unit is further configured to, if the judgment unit judges that the started camera device is not a front camera device, draw the current data frame of the viewfinder on the screen for displaying;
the drawing unit is be configured to, if the judgment unit judges that the beautification function of the started camera device is turned off, draw the current data frame of the viewfinder on the screen for displaying.

11. The device of claim 7, wherein the processing unit is further configured to, if the judgment unit judges that the beautification function of the started camera device is started, automatically perform the beautifying process on the data of the viewfinder read by the reading unit.

12. A mobile terminal comprising a processor, a memory, a front camera device, a rear camera device and a screen; wherein the processor and the memory are connected with each other via an internal bus; the memory stores a set of instructions for performing a method for controlling camera devices, the set of instructions to direct the processor to perform acts of:
reading a current data frame of a viewfinder of a started camera device when the started camera device is started for taking a selfie;
judging whether the started camera device is the front camera device;
if the started camera device is the front camera device, judging whether a beautification function of the front camera device is turned on;
if the beautification function of the front camera device is started, judging whether receiving an instruction of turning off the beautification function of the front camera device;
if not receiving the instruction of turning off the beautification function of the front camera device, automatically performing a beautifying process on data of the viewfinder and drawing a data frame obtained through the beautifying process on the screen for displaying;
if receiving the instruction of turning off the beautification function of the front camera device, turning off the beautification function of the front camera device.

13. The mobile terminal of claim 12, wherein the front camera device and the screen are located at a first side of the mobile terminal; the rear camera device is located at a second side of the mobile terminal; the first side and the second side are opposite sides of the mobile terminal.

14. The mobile terminal of claim 12, wherein the front camera device has lower pixels than the rear camera device.
